(19) United States
(12) Patent Application Publication
(10) Pub. No.: US 2010/0186554 A1
(43) Pub. Date: Jul. 29, 2010

(54) Wheel Wrench

(75) Inventor: Chih-Ching HSIEH, TAICHUNG COUNTY (TW)

Correspondence Address: BRIAN M. MCINNIS, 12th Floor, Ruttonjee House, 11 Duddell Street, Hong Kong, HK

(73) Assignee: Chih-Ching HSIEH, TAICHUNG COUNTY (TW)

(21) Appl. No.: 12/728,280

(22) Filed: Mar. 22, 2010

Related U.S. Application Data
(63) Continuation-in-part of application No. 12/166,325, filed on Jul. 2, 2008, now abandoned.
Application No. 12/166,325 is a continuation-in-part of application No. 12/128,615, filed on May 29, 2008, now abandoned.

(51) Int. Cl. B25B 13/46; B25B 23/16

(52) U.S. Cl. 81/63; 81/60; 81/61; 81/177.85

(57) ABSTRACT

A wheel wrench includes a body, a head, a fitting, and a ratcheting mechanism. The head is connected to one end of the body, wherein the length direction of the head and the length direction of the body are neither orthogonal nor parallel. The fitting is for a socket. The ratcheting mechanism couples the fitting to the head, wherein the length of the ratcheting mechanism is greater than the width of the fitting.

### RELATED APPLICATIONS

The present application is a continuation-in-part application of my application Ser. No. 12/166,325 filed Jul. 2, 2008, entitled “RATCHET TYPE BENDING SPANNER”, currently pending, which is a continuation-in-part application of my application Ser. No. 11/523,821 filed Sep. 19, 2006, now abandoned; and my application Ser. No. 12/128,615 filed May 29, 2008, entitled “RACHET WRENCH”. All of these applications are incorporated herein by reference.

### BACKGROUND

1. Technical Field

The present disclosure relates to tools. More particularly, the present disclosure relates to wrenches.

2. Description of Related Art

A wrench or spanner is a tool used to turn objects, such as nuts and bolts. General wrenches may include open-end wrenches, box-end wrenches, combination wrenches, flare-nut wrenches, adjustable wrenches, socket wrenches, torque wrenches, crowfoot wrenches, saltus wrenches, box spanners, and striking face box wrenches.

### SUMMARY

According to one embodiment of the present invention, a wheel wrench includes a body, a head, a fitting, and a ratcheting mechanism. The head is connected to one end of the body, wherein the length direction of the head and the length direction of the body are neither orthogonal nor parallel. The fitting is for a socket. The ratcheting mechanism couples the fitting to the head, wherein the length of the ratcheting mechanism is greater than the width of the fitting.

According to another embodiment of the present invention, a wheel wrench includes a body, a head, a fitting, and a ratcheting mechanism. The head is connected to one end of the body, wherein the length direction of the head and the length direction of the body are neither orthogonal nor parallel. The fitting is for a socket. The ratcheting mechanism allows the rotational motion of the fitting relative to the head in only one direction, wherein the width of the fitting is less than the length of the ratcheting mechanism.

### BRIEF DESCRIPTION OF THE DRAWINGS

FIG. 1 is a front view of a wheel wrench according to one embodiment of the present invention;

FIG. 2 is a three dimensional view of the part 2 of FIG. 1;

FIG. 3 is an exploded view of the part 2 of FIG. 1;

FIGS. 4A and 4B are sectional views taken along line 4-4 of FIG. 2;

FIGS. 5A and 5B are sectional views taken along line 5-5 of FIG. 2; and

FIG. 6 is a sectional view taken along line 6-6 of FIG. 2.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically depicted in order to simplify the drawings.

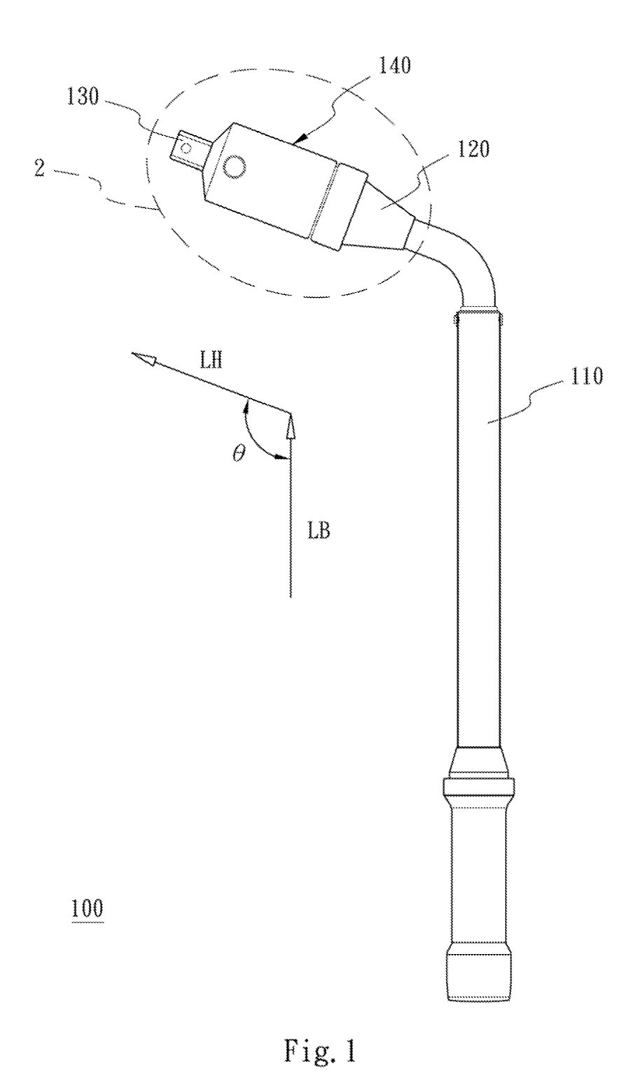

FIG. 1 is a front view of a wheel wrench 100 according to one embodiment of the present invention. As shown in FIG. 1, the wheel wrench 100 includes a body 110, a head 120, a fitting 130, and a ratcheting mechanism 140. The head 120 is connected to one end of the body 110, wherein the length direction LH of the head 120 and the length direction LB of the body 110 are neither orthogonal nor parallel. The ratcheting mechanism 140 couples the fitting 130 to the head 120, wherein the length of the ratcheting mechanism is greater than the width of the fitting.

In use, the ratcheting mechanism 140 allows the rotational motion of the fitting 130 relative to the head 120 in only one direction. Therefore, the wheel wrench 100 can tighten or loosen a nut with a reciprocating motion, without being removed or refitted after each turn.

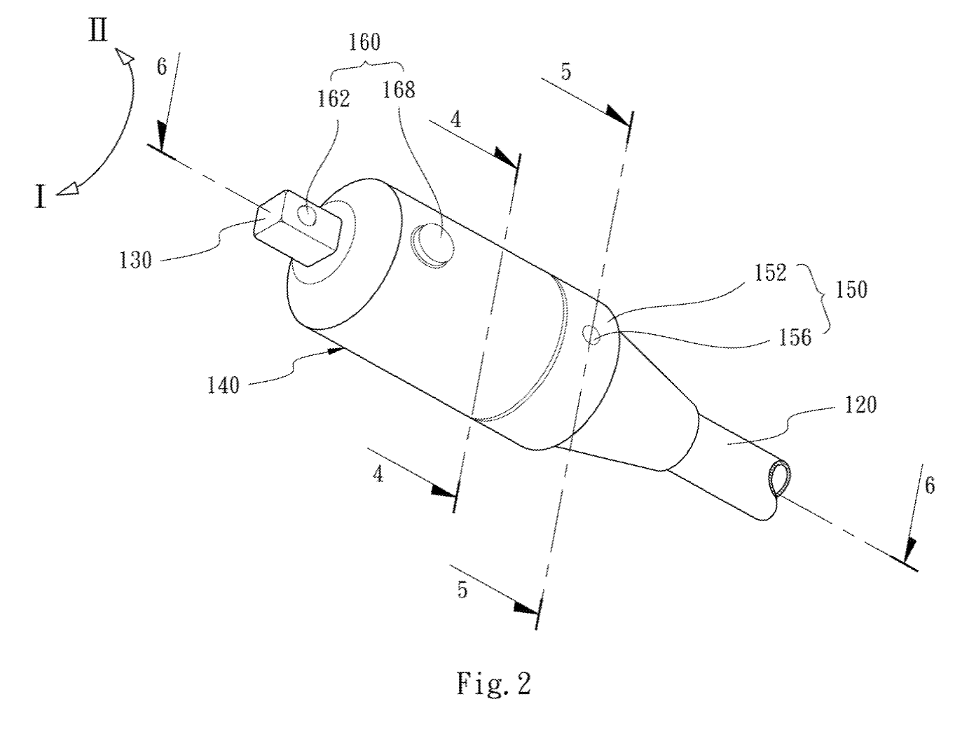

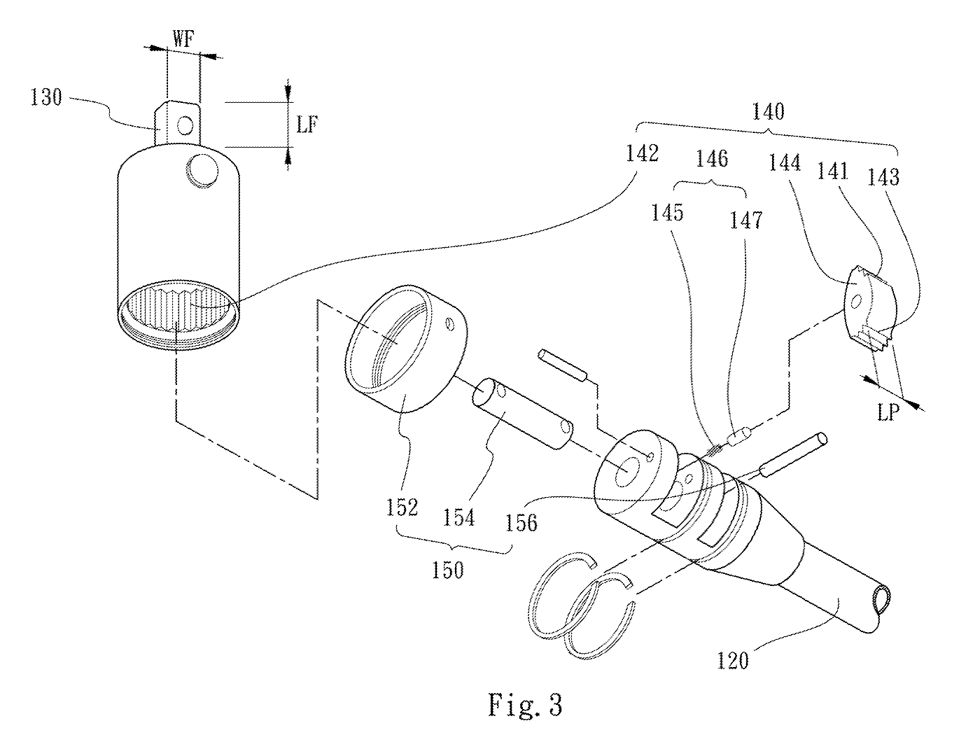

FIG. 2 is a three dimensional view of the part 2 of FIG. 1, and FIG. 3 is an exploded view of the part 2 of FIG. 1. As shown in FIGS. 2-3, the ratcheting mechanism 140 includes an outer gear 142, a pawl 144, and an elastic member 146. The fitting 130 is disposed at the front end of the outer gear 142. The pawl 144 is pivotally connected to the head 120 and has a plurality of teeth disposed thereon. The elastic member 146 can push the pawl 144 such that the teeth of the pawl 144 will engage the outer gear 142.

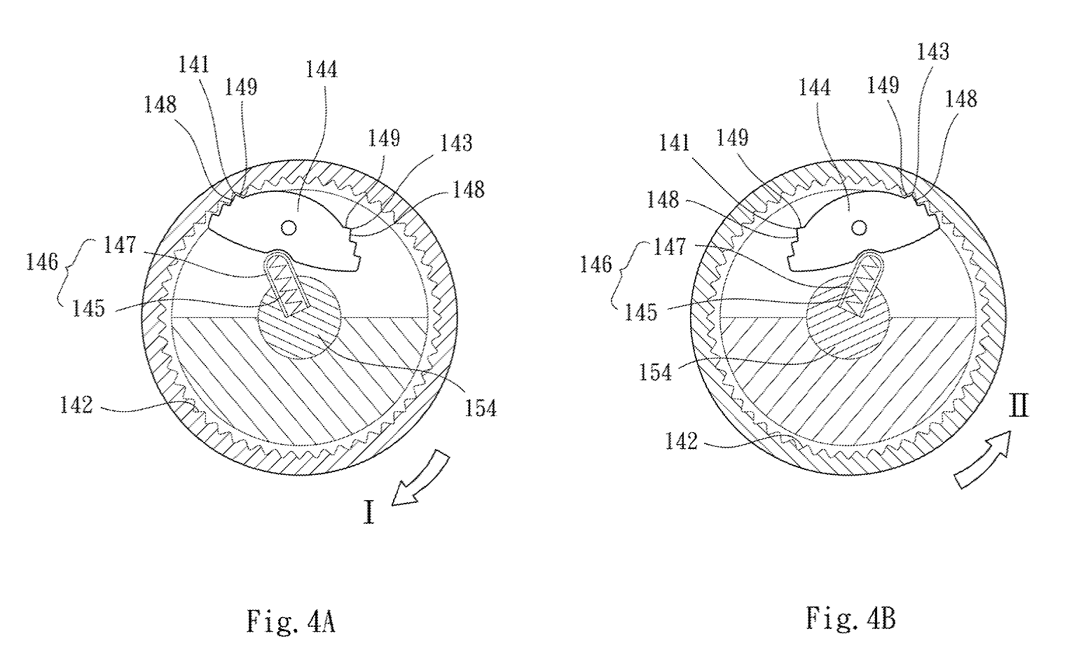

FIGS. 4A and 4B are sectional views taken along line 4-4 of FIG. 2 in different operating modes. The pawl 144 has a first teeth portion 141 and a second teeth portion 143. The first teeth portion 141 allows the rotational motion of the outer gear 142 relative to the head 120 in only a first direction I when the first teeth portion 141 engages the outer gear 142. The second teeth portion 143 allows the rotational motion of the outer gear 142 relative to the head 120 in only a second direction II when the second teeth portion 143 engages the outer gear 142.

Specifically, each tooth of the first teeth portion 141 has a moderate edge 148 and a steep edge 149. When the first teeth portion 141 engages the outer gear 142, and the outer gear 142 rotates in the first direction I, the pawl 144 will easily slides down and over the moderate edges 148 of the first teeth portion 141 (as shown in FIG. 4A). When the first teeth portion 141 engages the outer gear 142, and the outer gear 142 rotates in the second direction II, however, the pawl 144 will catch against the outer gear 142 by the steep edges 149 of the first teeth portion 141, thereby locking the outer gear 142 and preventing any further motion in the second direction II.

Similarly, each tooth of the second teeth portion 143 has a moderate edge 148 and a steep edge 149 as well. When the second teeth portion 143 engages the outer gear 142, and the outer gear 142 rotates in the second direction II, the pawl 144 will easily slides down and over the moderate edges 148 of the second teeth portion 143 (as shown in FIG. 4B). When the second teeth portion 143 engages the outer gear 142, and the outer gear 142 rotates in the first direction I, however, the pawl 144 will catch against the outer gear 142 by the steep edges 149 of the second teeth portion 143, thereby locking the outer gear 142 and preventing any further motion in the first direction I.

Return to FIGS. 2-3. The ratcheting mechanism 140 may further include a switching mechanism 150 for selecting the first teeth portion 141 or the second teeth portion 143 to engage the outer gear 142. Specifically, the switching mechanism 150 may include a switching ring 152, a shaft 154, and a fastener 156. The switching ring 152 is rotatably disposed around the head 120. The shaft 154 passes through the head 120, wherein the elastic member 146 is disposed on the side of the shaft 154. The fastener 156 fastens the switching ring 152 and the shaft 154.

In one or more embodiments, the fastener 156 may be a pin. It is appreciated that many other devices may be used as the fastener 156, for instance, a threaded fastener, such as a screw, may be substituted for the pin as the fastener 156.

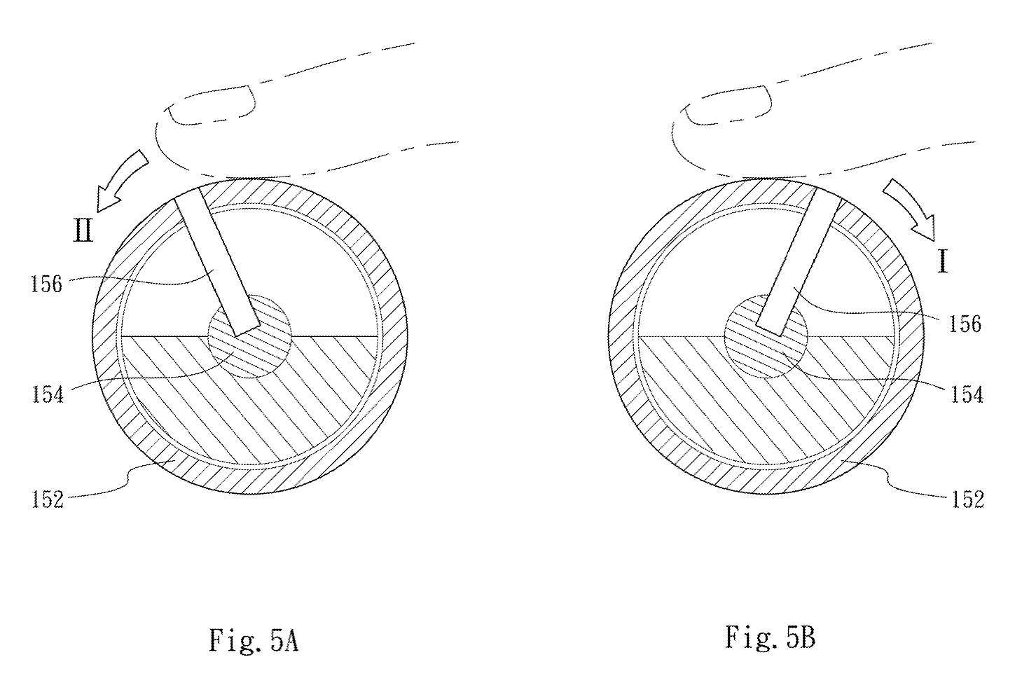

FIGS. 5A and 5B are sectional views taken along line 5-5 of FIG. 2 in different operating modes. In use, the user may turn the switching ring 152 counterclockwise to rotate the shaft 154 (as shown in FIG. 5A). Then, the elastic member 146 is moved to push the first teeth portion 141 to engage the outer gear 142 by the rotational motion of the shaft 154 (as shown in FIG. 4A). As a result of the engagement of the first teeth portion 141 with the outer gear 142, the outer gear 142 is allowed to be rotated relative to the head 120 in only the first direction I.

Alternatively, the user may turn the switching ring 152 clockwise to rotate the shaft 154 (as shown in FIG. 5B). Then, the elastic member 146 is moved to push the second teeth portion 143 to engage the outer gear 142 by the rotational motion of the shaft 154 (as shown in FIG. 4B). As a result of the engagement of the second teeth portion 143 with the outer gear 142, the outer gear 142 is allowed to be rotated relative to the head 120 in only the second direction II.

As shown in FIG. 3, the elastic member 146 may include a bullet-shaped cover 147 and a compressing spring 145. In use, the compressing spring 145 can push the bullet-shaped cover 147 against the pawl 144. It is appreciated that many other devices may be used as the elastic member 146, for instance, a leaf spring may be substituted for the bullet-shaped cover 147 and the compressing spring 145 as the elastic member 146.

In one or more embodiments, the width WF of the fitting 130 is less than the length LP of the teeth of the pawl 144. That is, the length LP of the teeth of the pawl 144 in one or more embodiments is greater than the width WF of the fitting 130 for securely engaging the outer gear 142. If the length LP of the teeth of the pawl 144 is less than the width WF of the fitting 130, the torque applied to the fitting 130 and the outer gear 142 may break the engagement of the outer gear 142 with the teeth of the pawl 144.

In one or more embodiments, the length LF of the fitting 130 is less than the length LP of the teeth of the pawl 144. That is, the length LP of the teeth of the pawl 144 in one or more embodiments is greater than the length LF of the fitting 130 for securely engaging the outer gear 142. If the length LP of the teeth of the pawl 144 is less than the length LF of the fitting 130, the torque applied to the fitting 130 and the outer gear 142 may break the engagement of the outer gear 142 with the teeth of the pawl 144.

In the present embodiment, the width WF of the fitting 130 is about 12.63-12.7 mm. The length LF of the fitting 130 is about 13.49-15.88 mm. The length LP of the teeth of the pawl 144 is greater than about 15.88 mm.

The term “length” as used herein means the longest dimension of an object. For example, the length LP of the teeth of the pawl 144 as disclosed herein means the longest dimension of the teeth of the pawl 144.

The terms “about” as used herein may be applied to modify any quantitative representation which could permissibly vary without resulting in a change in the basic function to which it is related. For example, the width WF of the fitting 130 as disclosed herein may permissibly be greater than 12.7 mm or less than 12.63 mm within the scope of the invention if its fitting capability is not materially altered.

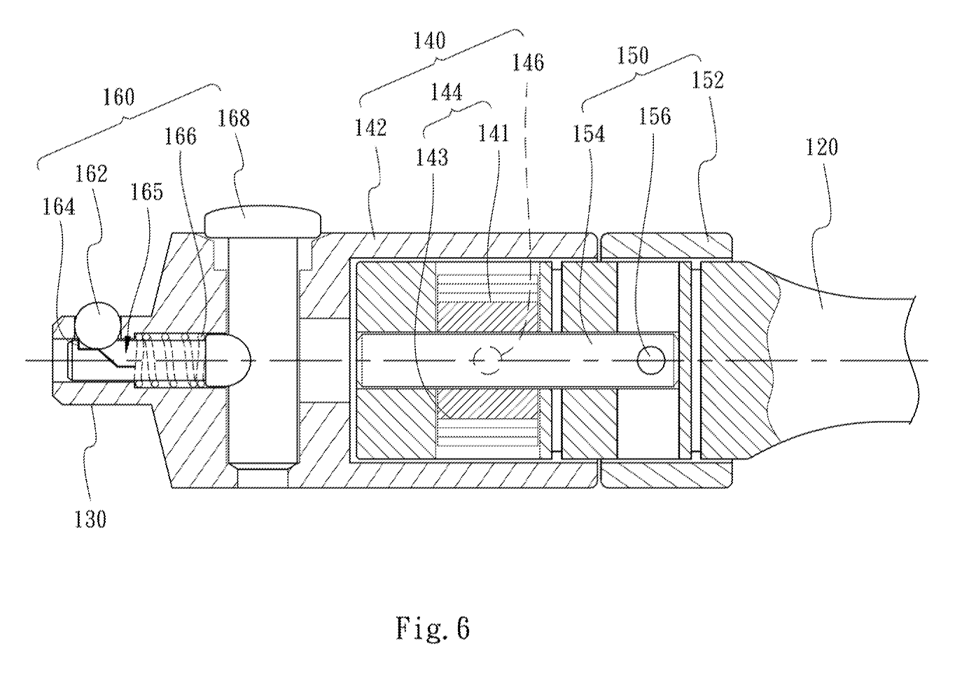

FIG. 6 is a sectional view taken along line 6-6 of FIG. 2. As shown in FIG. 6, the fitting 130 may contain a spring loaded ball detent mechanism 160 to keep the socket in place. The spring loaded ball detent mechanism 160 includes a ball 162, a plunger 164, a spring 166, and a button 168. In use, the ball 162 may protrude from the fitting 130 to engage a bearing recess in the socket. The plunger 164 pushes against the ball 162, and the plunger 164 has a plunger groove 165 located thereon. The spring 166 is disposed around the plunger 164, wherein one end of spring 164 is against the cap of the plunger 166, and the other end of the spring 164 is against the inner wall of the fitting 130. The button 168 is coupled to the plunger 164.

When releasing the socket, the user may push the button 168 to move the plunger 166 forwards. Then, the ball 162 is dropped into the plunger groove 165 to release the socket. After the user releases the button 168, the spring 164 returns the plunger 166 and the ball 162 to their original location.

The reader's attention is directed to all papers and documents which are filed concurrently with his specification and which are open to public inspection with this specification, and the contents of all such papers and documents are incorporated herein by reference.

All the features disclosed in this specification (including any accompanying claims, abstract, and drawings) may be replaced by alternative features serving the same, equivalent or similar purpose, unless expressly stated otherwise. Thus, unless expressly stated otherwise, each feature disclosed is one example only of a generic series of equivalent or similar features.

Any element in a claim that does not explicitly state “means for” performing a specified function, or “step for” performing a specific function, is not to be interpreted as a “means” or “step” clause as specified in 35 U.S.C. §112, 6th paragraph. In particular, the use of “step of” in the claims is not intended to invoke the provisions of 35 U.S.C. §112, 6th paragraph.

What is claimed is:

1. A wheel wrench comprising:
a body;
a head connected to one end of the body, wherein the length direction of the head and the length direction of the body are neither orthogonal nor parallel;
a fitting for a socket; and
a ratcheting mechanism coupling the fitting to the head, wherein the length of the ratcheting mechanism is greater than the width of the fitting.

2. The wheel wrench of claim 1, wherein the ratcheting mechanism comprises:
an outer gear, wherein the fitting is disposed at the front end of the outer gear;
a pawl pivotally connected to the head and having a plurality of teeth disposed thereon, wherein each tooth of the pawl has a steep edge and a moderate edge; and
an elastic member for pushing the pawl such that the teeth of the pawl will engage the outer gear.

3. The wheel wrench of claim 2, wherein the elastic member comprises:
a bullet-shaped cover; and
a compressing spring for pushing the bullet-shaped cover against the pawl.

4. The wheel wrench of claim 2, wherein the length of the teeth of the pawl is greater than the width of the fitting.

5. The wheel wrench of claim 2, wherein the length of the teeth of the pawl is greater than the length of the fitting.

6. The wheel wrench of claim 1, wherein the ratcheting mechanism comprises:
an outer gear, wherein the fitting is disposed at the front end of the outer gear;
a pawl pivotally connected to the head and having a first teeth portion for allowing the rotational motion of the outer gear relative to the head in only a first direction when the first teeth portion engages the outer gear and a second teeth portion for allowing the rotational motion of the outer gear relative to the head in only a second direction when the second teeth portion engages the outer gear;
an elastic member; and
a switching mechanism for moving the elastic member to push the first teeth portion of the pawl to engage the outer gear.

7. The wheel wrench of claim 6, wherein the switching mechanism comprises:
a switching ring rotatably disposed around the head;
a shaft passing through the head, wherein the elastic member is disposed on the side of the shaft; and
a fastener fastening the switching ring and the shaft.

8. The wheel wrench of claim 1, wherein the ratcheting mechanism comprises:
an outer gear, wherein the fitting is disposed at the front end of the outer gear;
a pawl pivotally connected to the head and having a first teeth portion for allowing the rotational motion of the outer gear relative to the head in only a first direction when the first teeth portion engages the outer gear and a second teeth portion for allowing the rotational motion of the outer gear relative to the head in only a second direction when the second teeth portion engages the outer gear;
an elastic member; and
a switching mechanism for moving the elastic member to push the second teeth portion of the pawl to engage the outer gear.

9. A wheel wrench comprising:
a body;
a head connected to one end of the body, wherein the length direction of the head and the length direction of the body are neither orthogonal nor parallel;
a fitting for a socket; and
a ratcheting mechanism for allowing the rotational motion of the fitting relative to the head in only one direction, wherein the width of the fitting is less than the length of the ratcheting mechanism.

10. The wheel wrench of claim 9, wherein the ratcheting mechanism comprises:
an outer gear, wherein the fitting is disposed at the front end of the outer gear;
a pawl pivotally connected to the head and having a plurality of teeth disposed thereon, wherein each tooth of the pawl has a steep edge and a moderate edge; and
an elastic member for pushing the pawl such that the teeth of the pawl will engage the outer gear.

11. The wheel wrench of claim 10, wherein the elastic member comprises:
a bullet-shaped cover; and
a compressing spring for pushing the bullet-shaped cover against the pawl.

12. The wheel wrench of claim 10, wherein the width of the fitting is less than the length of the teeth of the pawl.

13. The wheel wrench of claim 10, wherein the length of the fitting is less than the length of the teeth of the pawl.

14. The wheel wrench of claim 9, wherein the ratcheting mechanism comprises:
an outer gear, wherein the fitting is disposed at the front end of the outer gear;
a pawl pivotally connected to the head and having a first teeth portion for allowing the rotational motion of the outer gear relative to the head in only a first direction when the first teeth portion engages the outer gear and a second teeth portion for allowing the rotational motion of the outer gear relative to the head in only a second direction when the second teeth portion engages the outer gear;
an elastic member; and
a switching mechanism for moving the elastic member to push the first teeth portion of the pawl to engage the outer gear.

15. The wheel wrench of claim 14, wherein the switching mechanism comprises:
a switching ring rotatably disposed around the head;
a shaft passing through the head, wherein the elastic member is disposed on the side of the shaft; and
a fastener fastening the switching ring and the shaft.

16. The wheel wrench of claim 9, wherein the ratcheting mechanism comprises:
an outer gear, wherein the fitting is disposed at the front end of the outer gear;
a pawl pivotally connected to the head and having a first teeth portion for allowing the rotational motion of the outer gear relative to the head in only a first direction when the first teeth portion engages the outer gear and a second teeth portion for allowing the rotational motion of the outer gear relative to the head in only a second direction when the second teeth portion engages the outer gear;
an elastic member; and
a switching mechanism for moving the elastic member to push the second teeth portion of the pawl to engage the outer gear.

17. A wheel wrench comprising:
a body;
a head connected to one end of the body, wherein the length direction of the head and the length direction of the body are neither orthogonal nor parallel;
means for fitting a socket; and
means for allowing the rotational motion of the fitting means relative to the head in only one direction.
